(19) United States
(12) Patent Application Publication
(10) Pub. No.: US 2025/0077134 A1
(43) Pub. Date: Mar. 6, 2025

(54) INFORMATION PROCESSING APPARATUS, METHOD, AND STORAGE MEDIUM

(71) Applicant: CANON KABUSHIKI KAISHA, Tokyo (JP)

(72) Inventor: TAKUMI URYU, Chiba (JP)

(21) Appl. No.: 18/814,968

(22) Filed: Aug. 26, 2024

(30) Foreign Application Priority Data
Aug. 29, 2023 (JP) 2023-138694

(51) Int. Cl. G06F 3/12

(52) U.S. Cl. CPC G06F 3/1208; G06F 3/126

(57) ABSTRACT

When executing color validation, an information processing apparatus compares print settings of a print job immediately before a color validation print job with print settings of the color validation print job and transmits, as appropriate, a print job for preventing the increase in differences between the print settings to an image forming apparatus.

### BACKGROUND

### Field of the Disclosure

The present disclosure relates to controlling a system, an information processing apparatus, and an image forming apparatus for validating the color quality of a print product.

### Description of the Related Art

An image forming apparatus is known to generate a color shift in output colors due to individual differences, environmental dependence, or physical load changes in the apparatus. The execution of the color validation is known as a method for determining the occurrence of a color shift in output colors. In the color validation, an image forming apparatus outputs a color chart, an apparatus called a colorimeter performs colorimetry, and the color differences from ideal colors are calculated as color differences. If a color difference is larger than or equal to a predetermined threshold value, the user often determines that a color shift occurs and performs an operation for adjusting the output colors of the image output apparatus (i.e., calibration).

In the commercial printing field, the color validation is often performed on a regular basis. For example, in a printing house, a print operator performs the color validation at the opening time of day and checks whether a color shift occurs on an image forming apparatus. If a color shift occurs on the image forming apparatus, the print operator performs calibration on the image forming apparatus to adjust the output colors of the image forming apparatus. There has been disclosed a system for automatically performing these scheduled color validation processes.

In the color validation processes, color differences are known to be affected by physical changes in the image forming apparatus. These physical changes are known to be caused by various factors based on print settings, including the ink color, paper size, and paper type. Japanese Patent Application Laid Open No. 2008-238459 discloses a technique for changing the order of print commands that are print jobs in consideration of the difference in the degree of the influence on a color shift of an image forming apparatus between monochromatic printing and color printing.

Idle printing is also known as a method for solving a color shift caused by physical changes in the image forming apparatus. In the idle printing, a predetermined number of copies (e.g., 100 copies) are printed based on predetermined print settings aiming at smoothing physical changes occurring in the image forming apparatus. As a solution with the idle printing, an output disorder of the image forming apparatus under specific conditions is stabilized by continuously printing a predetermined number of copies based on predetermined print settings. Generally, a printing system performs printing through a print command called a print job transmitted from an information processing apparatus to an image forming apparatus. Not only normal printing but also color chart printing for the above-described color validation is performed through a print job. Many information processing apparatuses and image forming apparatuses include a print job control unit for controlling and managing printing on a print job basis.

The technique disclosed in Japanese Patent Application Laid Open No. 2008-238459 changes the order of print jobs to restrict the occurrence rate of a color shift due to the differences between print settings, thus reducing the frequency at which waiting time due to color shift correction arises. However, in a printing house, printing schedules of print products are often predetermined for each product line, and therefore changing the order of print jobs is often difficult on account of a production plan. If warm-up idle printing is performed each time to avoid a color shift due to differences between print settings, time usable for printing other than the idle printing decreases to reduce the printer operation rate, thus hampering user's convenience.

### SUMMARY

In view of the above-described issues, the present disclosure is directed to providing a method for solving a color shift without hampering user's convenience.

According to an aspect of the present disclosure, a method for an information processing apparatus capable of communicating with an image forming apparatus includes receiving an instruction for causing the image forming apparatus to execute a color validation print job, and controlling, in a case of causing the image forming apparatus to execute the color validation print job, whether to instruct the image forming apparatus to execute a print job for stabilizing operations of the image forming apparatus, based on print settings of a print job having been executed immediately before by the image forming apparatus and print settings of the color validation print job.

Further features of various embodiments will become apparent from the following description of exemplary embodiments with reference to the attached drawings.

### BRIEF DESCRIPTION OF THE DRAWINGS

FIG. 1 is a block diagram illustrating an entire color validation system according to a first exemplary embodiment.

FIG. 2 illustrates a hardware configuration of information processing apparatuses according to the first exemplary embodiment.

FIG. 3 is a functional block diagram illustrating the color validation system according to the first exemplary embodiment.

FIG. 4 illustrates settings to be stored in a color validation storage unit according to the first exemplary embodiment.

FIG. 5 illustrates an example of a color chart used for color validation according to the first exemplary embodiment.

FIG. 6 illustrates an example of print job management according to the first exemplary embodiment.

FIG. 7 illustrates examples of print settings of a print job according to the first exemplary embodiment.

FIG. 8 illustrates an example of a color validation setting screen according to the first exemplary embodiment.

FIG. 9 is a flowchart illustrating a scheduling function according to the first exemplary embodiment.

FIG. 10 is a flowchart illustrating processing when the color validation is started according to the first exemplary embodiment.

FIG. 11 illustrates an example of a color validation calendar screen according to the first exemplary embodiment.

FIG. 12 illustrates an example of capability information for an image forming apparatus according to a second exemplary embodiment.

FIG. 13 is a flowchart illustrating processing when the color validation is started according to the second exemplary embodiment.

FIG. 14 illustrates an example of print job management according to a third exemplary embodiment.

FIG. 15 is a flowchart illustrating processing for determining the necessity of an idle print job according to the third exemplary embodiment.

FIG. 16 is a flowchart illustrating advanced processing of a print job according to the third exemplary embodiment.

FIG. 17 illustrates an example of management information base (MIB) information according to the second exemplary embodiment.

### DESCRIPTION OF THE EMBODIMENTS

Exemplary embodiments of the present disclosure will be described in detail below with reference to the accompanying drawings. The following exemplary embodiments do not limit the every embodiment within the scope of the appended claims. Not all of the combinations of the features described in the exemplary embodiments are indispensable to the solutions for the present disclosure. The following exemplary embodiments and modifications may be suitably and selectively combined.

### [System Configuration]

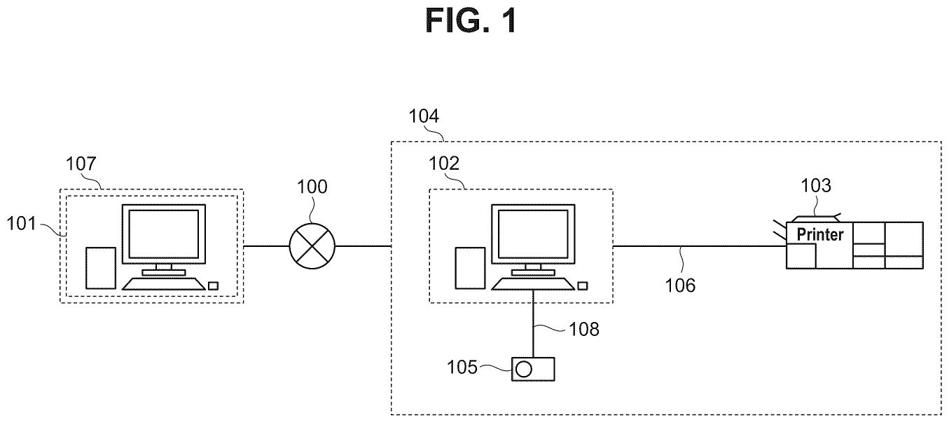

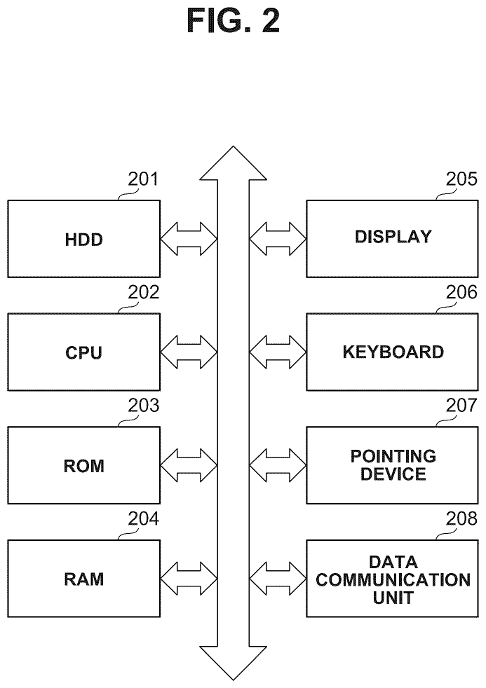

An image forming system, a color validation system, and a hardware configuration of information processing apparatuses according to a first exemplary embodiment will be described below with reference to the block diagrams in FIGS. 1 and 2. FIG. 1 is a block diagram illustrating a color validation system according to the present exemplary embodiment. The system is roughly classified into a web system 107 and a printing vendor system 104, which are connected with each other via a network 100 such as the Internet. The web system 107 includes an information processing apparatus 101 to manage and control an image forming apparatus. The web system 107 may be built on a cloud or on the server of each company.

An internal configuration of the printing vendor system 104 will be described in detail below. As illustrated in FIG. 1, an information processing apparatus 102 and an image forming apparatus 103 having a printing function are connected with each other via a network 106. The information processing apparatus 102 and a colorimeter 105 are connected with each other via a serial bus 108. The image forming apparatus 103 is controlled under a program group operating on the information processing apparatus 102 to process print settings and print data received from the web system 107 and produce a print product.

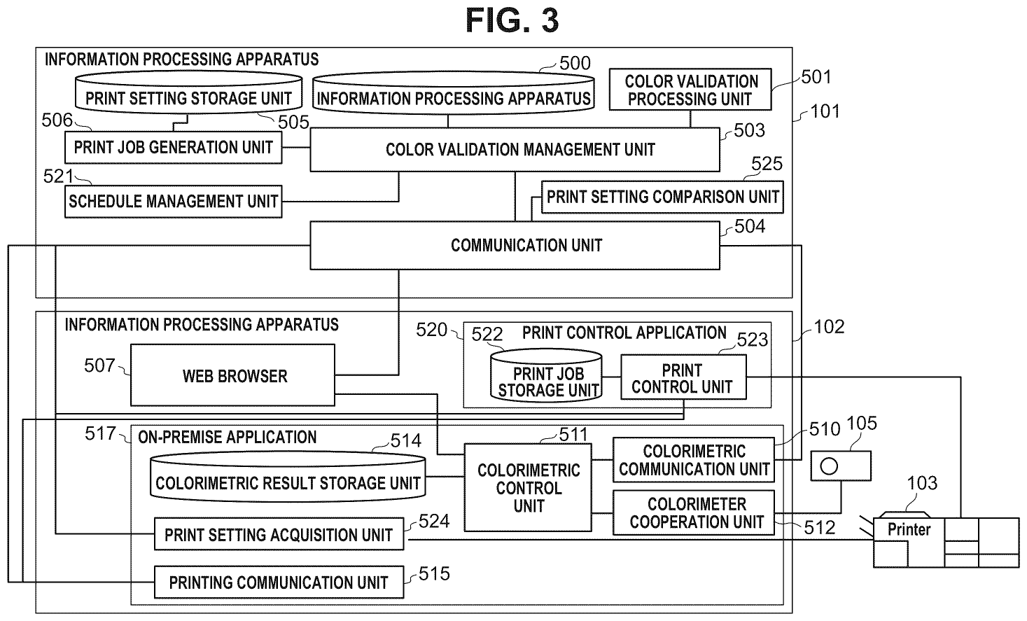

FIG. 2 is a block diagram illustrating a hardware configuration of the information processing apparatuses 101 and 102. Each of the information processing apparatuses 101 and 102 includes a central processing unit (CPU) 202 for performing calculations, and a storage unit including a hard disk drive (HDD) 201, a read only memory (ROM) 203, and a random access memory (RAM) 204. The CPU 202 controls the execution of a program stored in the storage unit and loaded into the RAM 204. The information processing apparatuses 101 and 102 include a display unit (e.g., a display 205), an operation reception unit (e.g., a pointing device 207 and a keyboard 206), and a data communication unit 208 serving as a set of controller apparatuses for managing a network and a data bus on the hardware. Examples of such information processing apparatuses include personal computers (PCs), smartphones, and tablet terminals. These apparatuses are capable of communicating with each other via various controllers and buses in the information processing apparatuses 101 and 102. The image forming apparatus 103 has a similar configuration and additionally includes a printer engine and a scanner. FIG. 3 is a block diagram illustrating functions of the web system 107 and the printing vendor system 104 configuring the color validation system according to the present exemplary embodiment. Each function is implemented when the CPU 202 executes a program stored in the storage unit.

First, a function block mounted on the information processing apparatus 102 of the printing vendor system 104 will be described. The information processing apparatus 102 includes a web browser 507, a print control application 520, an on-premise application 517, and a printing communication unit 515.

The web browser 507 communicates with a communication unit 504 to acquire content, such as web content. The web browser 507 then parses the acquired content and displays it. The web browser 507 can execute processing of a program described with such a programming language as JavaScript. The on-premise application 517 has a role of relaying accesses between the web system 107, the image forming apparatus 103, the colorimeter 105, and the web browser 507. For example, the web system 107 prints a chart using the image forming apparatus 103 via the on-premise application 517. In colorimetry of the printed chart, the web system 107 controls the colorimeter 105 via the on-premise application 517. The web browser 507 receives a color validation test generation instruction or a measurement instruction and displays the result of the color validation.

The colorimetric control unit 511 receives an instruction from the web browser 507 and controls the colorimeter 105 via a colorimeter cooperation unit 512. The colorimetric control unit 511 stores the result of reading in a colorimetric result storage unit 514. Upon reception of a colorimetry completion instruction from the web browser 507, the colorimetric control unit 511 receives, from the colorimetric result storage unit 514, a colorimetric result matching with the identifier (ID) in the colorimetry completion instruction and then transmits the result to the communication unit 504 via a colorimetric communication unit 510.

The colorimetric communication unit 510 performs communication between the colorimetric control unit 511 and the communication unit 504. Upon reception of the colorimetric result from the colorimetric control unit 511, the colorimetric communication unit 510 starts communicating with the communication unit 504 and transmits the colorimetric result to the communication unit 504. Although no specific communication method is given, the present exemplary embodiment uses Hyper Text Transfer Protocol (HTTP) communication.

The colorimeter cooperation unit 512, which is an interface with the colorimeter 105, mediates the exchange between the colorimetric control unit 511 and the colorimeter 105.

The printing communication unit 515 performs communication between the print control unit 523 and the communication unit 504. Upon reception of a print instruction from the user, the printing communication unit 515 receives a print job including the print settings and print data from the communication unit 504, receives the internet protocol (IP) address of the image forming apparatus as a communication destination, and transfers the IP address to the print control unit 523.

The print control application 520, which is a print management application for printing Portable Document Format (PDF) documents and Joint Photographic Experts Group (JPEG) images, includes the print control unit 523 and the print job storage unit 522. The print control application 520 receives a print command from outside and transmits the print command to the image forming apparatus 103 via the print control unit 523. By using the print control application 520, the user can manage printing on the image forming apparatus 103. The operation of the print control application 520 will be described in detail below.

The print setting acquisition unit 524 requests the print control unit 523 of the print control application 520 for the print settings of a print job and acquires the print settings. If the image forming apparatus 103 has a function of managing a print job similar to that of the print control application 520, the print setting acquisition unit 524 requests the image forming apparatus 103 for the print settings of the print job and acquires the print settings of the print job.

The colorimetric result storage unit 514 is a location where the colorimetric control unit 511 stores the colorimetric result of the colorimetric chart upon completion of the colorimetry on the colorimetric chart. The colorimetric result storage unit 514 stores, as a file, the colorimetric result in the storage unit, such as the HDD, of the information processing apparatus 102.

The print job storage unit 522 is a location where the print control application 520 stores a generated print job and a print job of the colorimetric chart. The print job storage unit 522 stores, as a file, a print job in the storage unit, such as the HDD, of the information processing apparatus 102. This completes the descriptions of the function blocks mounted on the information processing apparatus 102.

Function blocks mounted on the information processing apparatus 101 of the web system 107 will now be described. The communication unit 504 is a service program for performing HTTP communication with the web browser 507 to provide the web browser 507 with Hyper Text Markup Language (HTML) data and objects (e.g., images) to be displayed. The communication unit 504 also performs HTTP communication with the printing communication unit 515 to transmit a print job to the on-premise application 517. The communication unit 504 further performs HTTP communication with the colorimetric communication unit 510 to receive the colorimetric result of the color chart from the colorimetric communication unit 510.

The schedule management unit 521 automatically starts the color validation at a reserved time, based on the schedule settings stored in the colorimetric setting storage unit 500.

The color validation management unit 503 has a function of controlling the execution of each step of the color validation processing.

The color validation management unit 503 performs processing ranging from chart printing to colorimetry and color validation based on a user instruction input from the web browser 507. The color validation management unit 503 also stores the colorimetric result received by the communication unit 504 in the colorimetric result storage unit 514.

The colorimetric setting storage unit 500 is a location for storing the colorimetric settings input by the user. When the user inputs the colorimetric settings on the web browser 507 and stores the settings in the colorimetric setting storage unit 500, the web browser 507 transfers the colorimetric settings to the communication unit 504. The input of the colorimetric settings and the setting screen will be described below. When the communication unit 504 receives the colorimetric settings, the color validation management unit 503 stores the received colorimetric settings in the colorimetric setting storage unit 500.

A print setting comparison unit 525 compares the print settings of the two print jobs received via the communication unit 504 and performs determination. The print setting comparison unit 525 also confirms and determines the print settings for one print job. The actual determination performed by the print setting comparison unit 525 will be described in detail below with reference to a flowchart.

A print job generation unit 506 has a function of generating the print settings and print data. More specifically, the user issues a print instruction on the web browser 507. Upon issuance of the print instruction, the web browser 507 transmits a print instruction to the communication unit 504. When the communication unit 504 transfers the print instruction to the color validation management unit 503, the color validation management unit 503 acquires the colorimetric settings, based on the identifier (e.g., 00001) specified by the colorimetric setting storage unit 500 via the print instruction.

The color validation management unit 503 transfers the acquired colorimetric settings to the print job generation unit 506. The print job generation unit 506 generates a print job including the print settings of the chart and the print data satisfying the colorimetric settings. The print job generation unit 506 stores the generated print job in the print setting storage unit 505. The print setting storage unit 505 stores, as a file, the print job in the storage unit, such as the HDD, of the information processing apparatus 101. A print job is generated upon issuance of a print instruction by the user, upon issuance of a print instruction by the scheduling function, or at the timing when the colorimetric settings are stored in the colorimetric setting storage unit 500.

### <Print Application>

The operation of the print control application 520 will now be described. The print control application 520 performs printing by using the image forming apparatus 103 and manages and controls the printing schedules by using print jobs. The print control application 520 stores, as historical information, print setting information for print jobs having been executed by the image forming apparatus 103, and manages print jobs to be executed. In a printing house, the shipment schedule of print products is typically predetermined, and the print process is often planned according to the schedule. The print control application 520 is also used to generate a print process according to the above-described schedule. The print control application 520 having an interface for accepting a print command from an external application can transmit the received print command to the image forming apparatus 103 via the print control unit 523. The print control application 520 also has an interface for returning, upon request, the printing schedules and the print job execution history in a format (e.g., JavaScript Object Notation (JSON)) interpretable by other applications. For example, when the print control unit 523 receives a print job from the printing communication unit 515, the print control unit 523 transmits the print job to the image forming apparatus 103 having the IP address included in the received information. Although the present exemplary embodiment assumes HTTP communication as a method for transmitting a print job, the method is not limited thereto. Other print job transmission methods, such as Universal Serial Bus (USB) and Hot Folder, are also applicable.

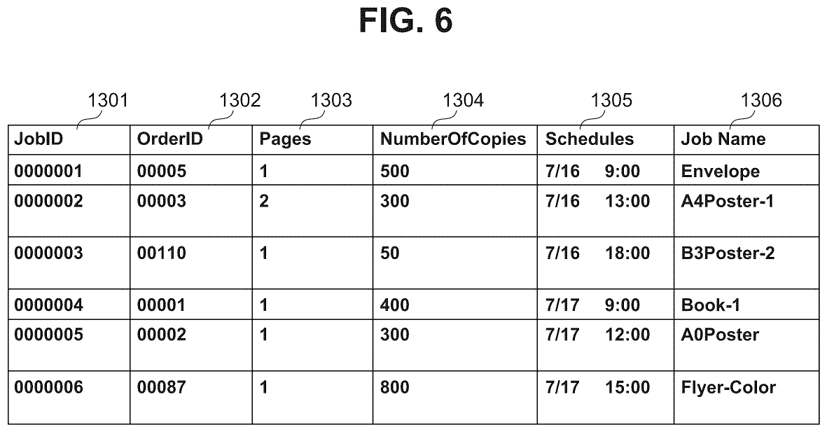

FIG. 6 illustrates a print job management screen using the print control application 520, which appears on, for example, the web browser 507. A column 1301 indicates the job ID serving as identification information for print jobs. A column 1302 indicates the order ID serving as identification information for orders. Since a printing house produces print products according to orders, the printing house manages print products by associating the order ID with print jobs. In a case of performing printing through a plurality of print jobs for one order, a plurality of the job IDs is associated with one order ID. There is a print job not having the order ID, such as a print job for test printing. A column 1303 indicates the number of pages for each print job. A column 1304 indicates the number of copies for each print job. A column 1305 indicates the printing time scheduled for each print job. When the printing time described in the column 1305 arrives, the print control application 520 starts printing the specified print job. If no printing time schedule is set, the print control application 520 promptly performs printing for a print job after the immediately preceding print job has been processed. A column 1306 indicates the name of each print job. Assigning an optional name to a print job allows the user to easily identify the contents of the print job. The print control application 520 stores and manages the above-described elements displayed in the print job management screen.

The above-described configurations and arrangements of different function units are not limited thereto. Other information processing apparatuses (not illustrated) may have some of the above-described function units. Some function units of the information processing apparatus 101 may be included in the information processing apparatus 102, or vice versa.

### <Print Job Information>

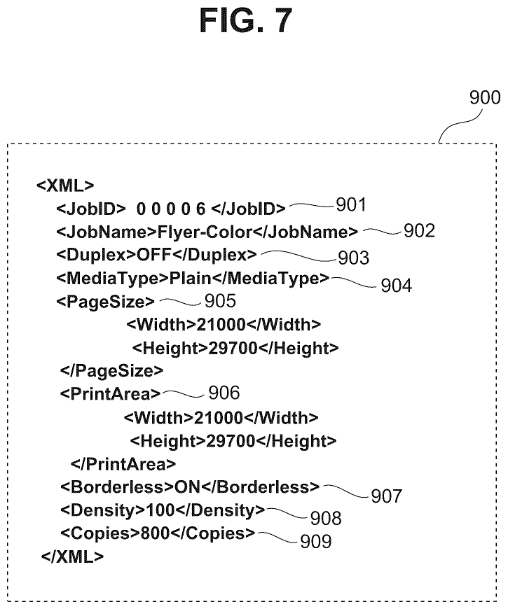

FIG. 7 illustrates an example of job information generated by the job generation unit 506. The job information is stored in a job storage unit of the information processing apparatus 101. The job information for a print job is expressed in the extended Markup Language (XML) format. The above-described expression formats of the job information are to be considered as examples. Examples of applicable formats include vendor-specific binary formats and the JSON format. The job information for a print job includes the description of the print settings of the print job. An identifier 901 indicates the identification number of the print job, where a value “00006” is specified. An identifier 902 indicates the name of the print job, where a value “Flyer-Color” is specified. A Duplex identifier 903 indicates the ON/OFF state of the two-sided printing function. An identifier 904 indicates the paper type, where “Plain” (plain paper) is specified. An identifier 905 indicates the paper size and includes the values corresponding to the identifiers representing the width and height. The width and height values are described in units of 0.01 mm (millimeters) (0.01 mm=1 unit). An identifier 906 describes the size of the printing area with respect to the paper size. An identifier 907 indicates the ON/OFF state of the borderless print setting. If the value of the identifier 907 is set to ON, the borderless printing is performed. If the value is set to OFF, the bordered printing is performed. The information for the identifiers 905 and 906 can also be used to determine whether the borderless print function is enabled. This determination may be performed by using only the identifiers 906 and 905, by using only the information for the identifier 907, or by using a combination thereof. The present exemplary embodiment does not limit the method. An identifier 908 indicates the print density, where a value 100 is described in FIG. 7. The larger the value of the identifier 908, the more the image forming apparatus discharges toner or ink per unit area, and the higher becomes the print density of the print product. An identifier 909 indicates the number of copies to be printed, where a value 800 is described in FIG. 7. The image forming apparatus 103 prints print products of which the number of copies is described in the identifier 909.

### <Setting Screen>

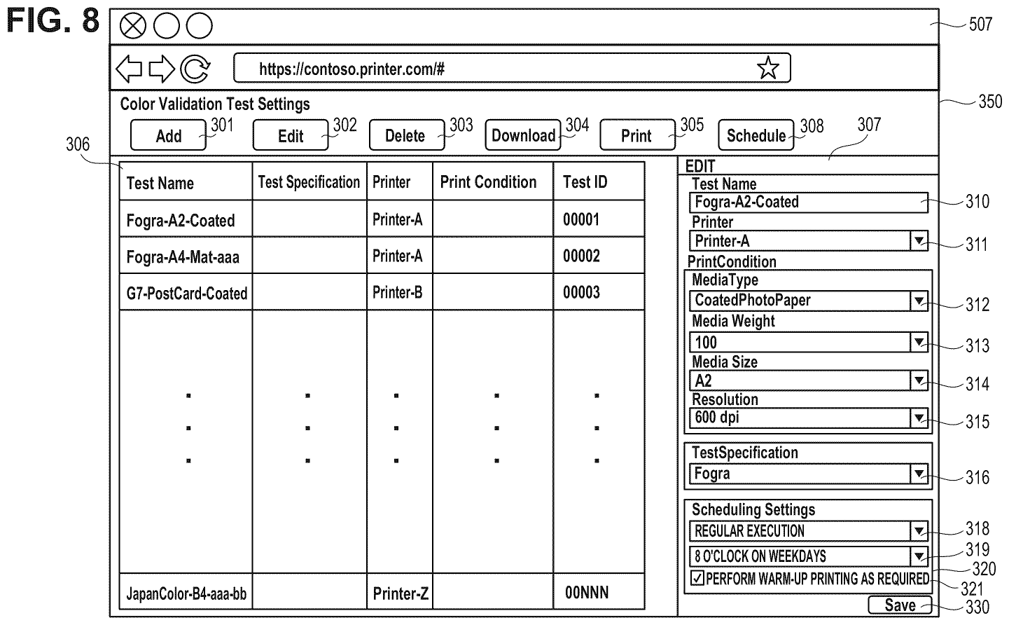

FIG. 8 illustrates an example of a color validation setting screen displayed on the web browser 507.

A display area 350 is a region for displaying the contents of a web page. A colorimetric setting list 306 indicates a list of color validation items to be used for the color validation and displays some of the settings to be used for the color validation together with setting item names. Each row indicates one setting. A colorimetric setting addition (Add) button 301 is used to add a new colorimetric setting to the colorimetric setting list 306. When the user presses the colorimetric setting addition button 301, a colorimetric setting editing area 307 appears allowing the user to input information to be used to generate a setting.

A colorimetric setting editing (Edit) button 302 allows the user to edit and change an existing colorimetric setting in the colorimetric setting list 306. When the user selects a setting displayed in the colorimetric setting list 306 and then presses the colorimetric setting editing button 302, the colorimetric setting editing area 307 appears allowing the user to change the selected colorimetric setting.

A colorimetric setting deletion (Delete) button 303 allows the user to delete an existing colorimetric setting in the colorimetric setting list 306. When the user selects a setting displayed in the colorimetric setting list 306 and then presses the colorimetric setting deletion button 303, the color validation management unit 503 deletes the colorimetric setting selected by the colorimetric setting storage unit 500.

A print data download (Download) button 304 is used to download the print data of the chart in a specified local folder. For example, if the user wants to perform the color validation on an image forming apparatus not supported by the color validation system, the color validation system is sometimes unable to perform printing with the image forming apparatus. The user is thus able to download once the print data of the chart in the local folder and then separately print the downloaded print data by using a printer driver.

A print (Print) button 305 is used to directly issue an instruction for printing the chart from the web system 107 to the image forming apparatus 103. For example, when the user presses the print button 305, the web browser 507 transmits an instruction for printing the selected colorimetric settings to the communication unit 504. The communication unit 504 then transfers the print instruction to the color validation management unit 503. The print job generation unit 506 generates a print job including the print settings of the chart and the print data satisfying the colorimetric settings. The print job generation unit 506 then transfers the generated print job to the color validation management unit 503. The color validation management unit 503 transmits the print job and the IP address of the image forming apparatus 103 to the on-premise application 517 via the communication unit 504. The on-premise application 517 transmits the print job to the image forming apparatus 103. The image forming apparatus 103 outputs a print product based on the print job. The user performs the colorimetry on the output print product and then performs the color validation.

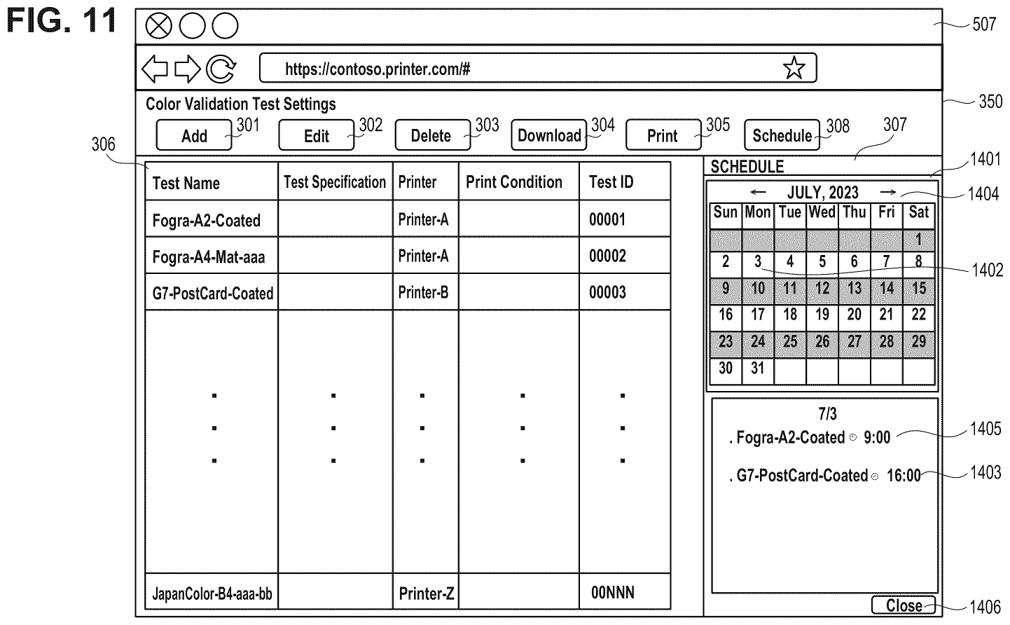

A schedule display (Schedule) button 308 is used to display a calendar for displaying a scheduled color validation list. When the user presses the schedule display button 308, a calendar display screen 1401 in FIG. 11 appears allowing the user to confirm the scheduled color validation. A calendar display function will be described below.

A colorimetric setting storage (Save) button 330 is used to store the colorimetric settings edited and set in the colorimetric setting editing area 307. When the user presses the colorimetric setting button 330, the information processing apparatus 102 communicates with the communication unit 504 via the web browser 507. The color validation management unit 503 then applies an identifier (e.g., 000001) to the colorimetric settings and stores the settings, in the JSON format typically used by web systems, in the colorimetric setting storage unit 500.

### <Editing Screen Items>

Setting items in the colorimetric setting editing area 307 will now be described.

A setting item 310 is used to specify the name of the colorimetric settings allowing the user to set an optional name.

A setting item 311 is used to specify a printer subjected to the colorimetry. The user can select a printer from among the printers connected with the on-premise application 517.

Setting items 312, 313, 314, and 315 are used to set the print settings to be used in the colorimetry. A setting item 312 is used to set the paper type, a setting item 313 is used to set the paper weight, a setting item 314 is used to set the paper size, and a setting item 315 is used to set the resolution by the user. The on-premise application 517 may have predetermined setting item types or preset items as selectable items. Selectable items may be generated based on the capability information for the image forming apparatus 103 obtained via the print control unit 523 or a printer driver.

A setting item 316 is used to select the color reference to be used for the colorimetry. Display items may include the standard print color reference or a user-defined print color reference. The standard print color reference has, for example, GRACOL in U.S., FOGRA in Europe, and Japan Color in Japan that are different from region to region. The chart format to be used for the colorimetry and the layout of the color patch to be used for the chart are determined according to the color reference selected by the setting item 316 for selecting the color reference.

Setting items 318, 319, 320, and 321 relate to the scheduling function. By combining these setting items, the user can automatically perform the color validation at the specified time or at regular intervals.

For example, if the user selects regular execution for the setting item 318 and specifies 8:00 a.m. on weekdays for the setting item 319, the color validation is regularly performed at 8:00 a.m. on weekdays. A setting item 321 is used to compare the print settings of a color validation print job with the print settings of a print job to be executed immediately before the color validation print job and determine whether to enable the idle printing function as required. If the setting item 321 is checked, the relevant function is enabled. The method for determining whether to enable the idle printing function will be described below since this determination is made when the color validation processing is started.

### <Color Validation Settings Stored in Color Validation Setting Storage Unit>

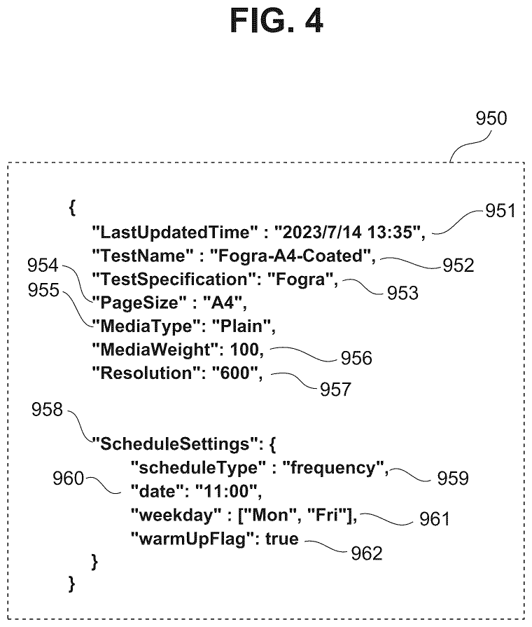

The color validation settings to be stored in the colorimetric setting storage unit 500 when the user presses the button 330 in the colorimetric setting editing area 307 will now be described with reference to FIG. 4. The settings illustrated in FIG. 4 are examples of the above-described color validation settings. A character string 950 includes the entire setting values for the color validation settings stored in the JSON format. A character string 951 indicates the date when the setting values are last updated. A character string 952 indicates the name of the color validation, where “Fogra-A4-Coated” is set. A character string 953 indicates the type of the color validation reference to be used for the color validation, where “Fogra” is set.

A character string 954 indicates the paper size, where “A4” is set. A character string 955 indicates the paper type, where “Plain” paper is set. A character string 956 indicates the paper weight, where 100 is set. A character string 957 indicates the resolution to be used in printing the chart for the color validation, where 600 is set. A character string 958 indicates the identifier indicating a set of the schedule settings. A character string 959 indicates how the schedule settings are to be executed. For example, if “frequency” is set to the character string 959, the schedule settings will be regularly executed on a week-to-week basis. A character string 960 indicates the time when the color validation is to be executed, where “11:00” is set. A character string 961 indicates the day of week when the color validation is to be executed, where Monday and Friday are set. A character string 962 indicates the setting value to be used when the color validation is automatically executed by the scheduling function. The setting value is used to select whether to perform the idle printing (described below) according to the differences between the print settings of a color validation print job and the print settings of a print job immediately before the color validation print job. Idle printing refers to transmitting a print job to the image forming apparatus 103 and printing the print job. The print job (hereinafter referred to as an idle print job) aims at stabilizing the operation of the image forming apparatus 103 before the color validation print job is printed. If the setting value of the character string 962 is “true”, the selection setting is enabled. If the setting value is “false”, the selection setting is disabled. “True” is set to the character string 962.

### <Scheduling Function>

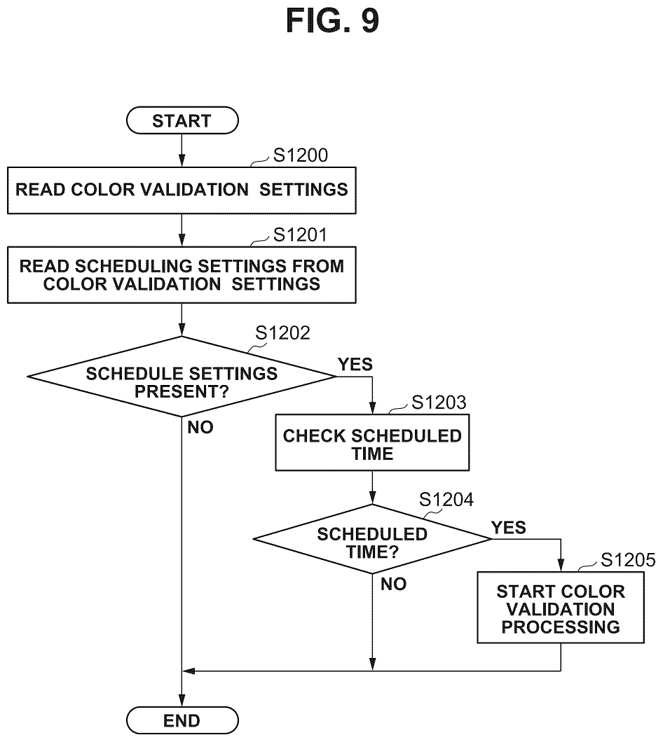

The scheduling function will now be described with reference to the flowchart in FIG. 9. In step S1200, the schedule management unit 521 reads the color validation settings stored in the colorimetric setting storage unit 500. The processing proceeds to step S1201. In step S1201, the schedule management unit 521 reads schedule-related settings from the color validation settings. The processing proceeds to step S1202. The schedule management unit 521 checks and determines whether schedule settings are included in the schedule-related settings.

If the schedule management unit 521 determines that the schedule settings are included (YES in step S1202), the processing proceeds to step S1203. If the schedule management unit 521 determines that the schedule settings are not included (NO in step S1202), the processing exits this flowchart. In step S1203, the schedule management unit 521 refers to the schedule settings to confirm the scheduled time. The processing proceeds to step S1204. In step S1204, the schedule management unit 521 checks and determines whether the current time is scheduled time.

If the current time is scheduled time (YES in step S1204), the processing proceeds to step S1205. If the current time is not scheduled time (NO in step S1204), the processing exits this flowchart. In step S1205, since the scheduled time has come, the schedule management unit 521 starts the color validation processing. The start of the color validation processing will be described in detail below.

The schedule management unit 521 regularly executes these pieces of processing (e.g., at intervals of one minute) to implement the function of performing the scheduled color validation.

### <Calendar Display>

The web browser 507 includes a calendar display function for confirming the set status of the schedule set by the user. FIG. 11 illustrates a state where the web browser 507 displays a calendar by using the calendar display function. The web browser 507 displays the screen based on the contents acquired from the communication unit 504.

The calendar display screen 1401 includes a calendar 1404 at the top and a schedule display portion 1403 at the bottom. The schedule display portion 1403 displays the schedule list of the date selected in the calendar 1404. If the user presses a Close button 1406, the calendar display screen 1401 does not appear. If the user selects a date portion 1402 (e.g., July 3) in the calendar 1404, the display in the schedule display portion 1403 changes in response to the selection, and a list of the color validations scheduled for the selected date appears. A scheduled item 1405 is a character string indicating the name of the color validation scheduled at 9:00 a.m. on July 3 and the relevant time. The clock mark displayed in the character string (scheduled item) 1405 corresponds to whether the setting item 321 is checked. If the setting item 321 is checked, the clock mark appears. If the setting item 321 is not checked, the clock mark does not appear. If the idle printing is performed on the image forming apparatus 103, the required time for the color validation increases to accordingly decrease the operation time during which the image forming apparatus 103 performs printing for other than the color validation. In a printing house, it may be more desirable that the user knows the possibility that the idle printing affects the existing printing schedule on account of convenience of the delivery date of print products. Even in such a case, turning the display of the mark ON or OFF allows the user to know that the idle printing accompanying the color validation affects the operation time of the image forming apparatus 103.

### <Color Chart>

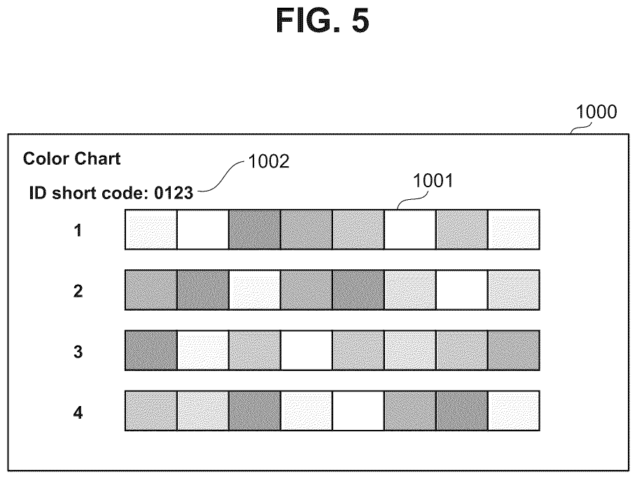

FIG. 5 illustrates an example of a color chart to be printed in the color validation. If a color validation print job is printed, a color chart 1000 is printed according to the print settings included in the print job. The color chart 1000 is printed with a plurality of rows of color patches 1001 formed side by side. The layout and the color type of the color patches 1001 differ according to the type of the color validation reference. For the printed color chart, the user performs the colorimetry on the color patches 1001 by using the colorimeter 105 to read the colors. The color validation management unit 503 processes the read colors and obtains the differences from the values of different color patches defined in the color reference. A short code ID 1002 associates the color validation stored in the colorimetric setting storage unit 500 with the color chart. If the user inputs the short code ID 1002 to the on-premise application 517, the on-premise application 517 transmits the colorimetric result to the communication unit 504 via the web browser 507, and the color validation management unit 503 associates the colorimetric result with the colorimetric settings and stores the colorimetric result in the colorimetric setting storage unit 500. According to the present exemplary embodiment, the detailed description of the processing will be omitted.

### <Start of Color Validation Processing>

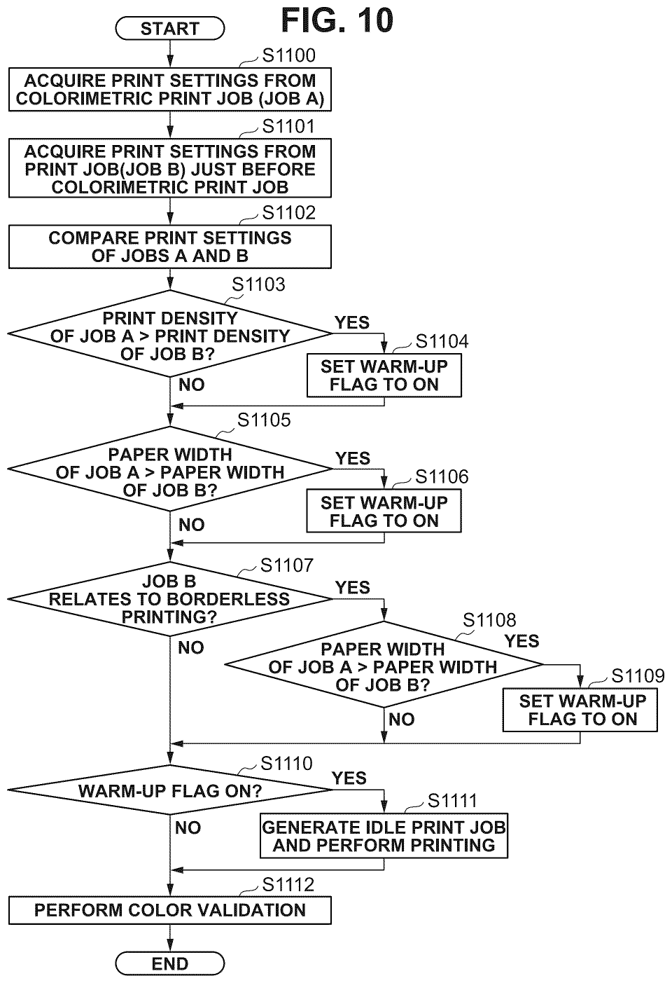

The on-premise application 517 starts the color validation through the manual execution by the user or the automatic execution by the scheduling function. In this case, the on-premise application 517 requests the print setting comparison unit 525 to perform processing before starting the color validation. A flow of processing performed when the print setting comparison unit 525 receives the relevant request and starts the color validation will be described with reference to the flowchart in FIG. 10. This flowchart is executed, for example, when an instruction for executing a color validation print job is received from the user. The processing of this flowchart is executed if the setting item 321 is checked.

In step S1100, the print setting comparison unit 525 sets the initial value of the warm-up flag to OFF and acquires the print settings from the color validation print job. The processing proceeds to step S1101. In step S1101, the print setting comparison unit 525 acquires the print settings of the print job having been executed immediately before by the target image forming apparatus 103 from the print job execution history. The processing proceeds to step S1102. In step S1102, the print setting comparison unit 525 compares the print settings of the color validation print job (hereinafter referred to as a job A) with the print settings of the print job having been executed immediately before (hereinafter referred to as job B). The processing proceeds to step S1103. In step S1102, the print setting comparison unit 525 compares the print density of the job A with the print density of the job B. The print setting comparison unit 525 performs this determination by referring to the “Density” tag included in the print settings accompanying the above-described print job and comparing the numerical values of the print densities. If the print setting comparison unit 525 determines that the print density of the job A is larger than the print density of the job B (YES in step S1103), the processing proceeds to step S1104. If the print density of the job A is equal to or smaller than the print density of the job B (NO in step S1103), the processing proceeds to step S1105. In step S1104, the print setting comparison unit 525 sets the warm-up print flag to ON. The processing proceeds to step S1105.

The print setting comparison unit 525 compares the paper width of the job A with the paper width of the job B. If the paper width of the job A is larger than the paper width of the job B (YES in step S1105), the processing proceeds to step S1106. If the paper width of the job A is equal to or smaller than the paper width of the job B (NO in step S1105), the processing proceeds to step S1107. In step S1106, the print setting comparison unit 525 sets the warm-up flag to ON. The processing proceeds to step S1107.

The print setting comparison unit 525 confirms and determines whether the job B relates to the borderless printing.

The print setting comparison unit 525 performs this determination by referring to the “Borderless” tag in the print setting accompanying the above-described print job. If the borderless printing is set to ON in the print settings of the job B (YES in step S1107), the processing proceeds to step S1108. If the borderless printing is set to OFF in the print settings of the job B (NO in step S1107), the processing proceeds to step S1110. In step S1108, the print setting comparison unit 525 compares the paper width of the job A with the paper width of the job B. If the paper width of the job A is larger than the paper width of the job B (YES in step S1108), the processing proceeds to step S1109. If the paper width of the job A is smaller than or equal to the paper width of the job B (NO in step S1108), the processing proceeds to step S1110. In step S1109, the on-premise application 517 sets the warm-up flag to ON, and the processing proceeds to step S1110. In this case, the threshold value for the determination may be differentiated between the determination of the difference in the paper width in step S1105 and the determination of the difference in the paper width in step S1108. For example, in step S1105, if the paper width of the job A is larger than the paper width of the job B by 1 cm (centimeter) or more, the on-premise application 517 sets the warm-up flag to ON. Otherwise, the on-premise application 517 does not set the warm-up flag to ON. In step S1108, if the paper width of the job A is larger than the paper width of the job B by 1 mm or more, the on-premise application 517 sets the warm-up flag to ON. Otherwise, the on-premise application 517 does not set the warm-up flag to ON.

In step S1110, the print setting comparison unit 525 confirms and determines whether the warm-up flag is ON. If the warm-up flag is ON (YES in step S1110), the processing proceeds to step S1111. If the warm-up flag is OFF (NO in step S1110), the processing proceeds to step S1112. In step S1110, the print setting comparison unit 525 determines that the stabilization processing for the image forming apparatus 103 through the idle printing is desired and generates an idle print job. The processing proceeds to step S1111. In the generation of an idle print job, the print setting comparison unit 525 copies the same job as the job A via the print control unit 523, generates an idle print job with the number of copies set to 100, and transmits the job to the image forming apparatus 103 via the communication unit 504, the printing communication unit 515, and the print control unit 523. In step S1111, upon reception of the idle print job, the image forming apparatus 103 performs printing aiming for the stabilization.

The print setting comparison unit 525 returns control to the on-premise application 517. In step S1112, the on-premise application 517 transmits the job A, which is a color validation print job, to the image forming apparatus 103 via the print control unit 523. The print setting comparison unit 525 then performs the color validation. The image forming apparatus 103 performs printing based on the transmitted print job, performs the colorimetry on the generated chart, and performs the color validation based on the colorimetry value and the reference value.

The above-described configuration allows the on-premise application 517, when performing the color validation, to compare the print settings of the print job printed immediately before a color validation print job with the print settings of the color validation print job, and determine whether to perform printing for the idle print job based on the differences between the print settings. The configuration of the present exemplary embodiment allows the user to perform the idle printing only if the idle printing is performed before performing the color validation. This enables avoiding the execution of useless idle printing, i.e., improving the success rate of the color validation while improving the printer operation rate. If the setting item 321 is not checked, the idle printing may be executed every time a color validation print job is executed or may not be executed on a regular basis.

Examples of cases where the output of the image forming apparatus 103 becomes unstable due to physical changes include, for example, the following three different cases. In the first case, if the image forming apparatus 103 performs high-density printing and then low-density printing, the output accuracy of ink toner becomes unstable, resulting in a color shift of a print product. In the second case, if the image forming apparatus 103 performs printing on paper or a medium with a small width and then printing on paper or a medium with a large width, the belt load of the sheet conveyance path becomes uneven, and the distance between the ink head and the paper becomes uneven, resulting in a color shift of the print product. In the third case, if the image forming apparatus 103 once having performed the borderless printing performs printing on paper with a larger width, the ink adhering to the paper supporting portion (platen) adheres to the back surface of the paper. Stains on the back surface of the paper are read through at the time of the light-based color validation and are detected as a color shift. Typically, an ink-jet image forming apparatus implements the borderless printing by outputting ink to the width exceeding the paper, the above-described methods produce stains on the platen, resulting in a color shift. If the differences between the print settings of the print job having been executed immediately before and the print settings of the print job to be executed may cause a color shift, the above-described flowchart enables performing the idle printing with the warm-up flag set to ON. If the possibility of a color shift is low, the image forming apparatus 103 does not perform the idle printing, improving the printer operation rate. In the above-described flowchart, the print setting comparison unit 525 determines the necessity of the idle printing based on three different viewpoints, however, the print setting comparison unit 525 may perform this determination based on other viewpoints or on at least one of the three viewpoints.

According to the first exemplary embodiment, the print setting comparison unit 525 compares the print settings of a color validation print job and the print settings of the print job immediately before the color validation print job, predicts occurrence of stains of the platen by the borderless printing based on the differences between the two different print settings, and determines whether to perform printing of an idle print job. Stains of the platen occur only in ink-jet image forming apparatuses. Some models of image forming apparatuses do not support the borderless printing. For example, the borderless print function is often used for photographic printing applications. However, since this function is not used for image forming apparatuses for office uses, the function is omitted on account of manufacturers of image forming apparatuses in many cases. In view of the above-described situations, when determining the necessity of printing an idle print job, referring to the capability information for an image forming apparatus enables correct determination. As a modification of the first exemplary embodiment, a second exemplary embodiment will now be described centering on a method for determining the necessity of the idle printing by using the capability information regarding the image forming apparatus. Basic configurations of the second exemplary embodiment are common to those of the first exemplary embodiment. Descriptions common to those of the first exemplary embodiment will thus be omitted, and only the points different from the first exemplary embodiment will be described.

### <Acquiring Model Capability Information>

Generally, in a known technique, a capability information acquisition request is issued to an image forming apparatus through a predetermined protocol, and capability information is acquired from the image forming apparatus that receives the request. For example, with the Windows® operating system (OS) as basic software from Microsoft® Corporation, the capability information for an image forming apparatus can be acquired by using a predetermined application programming interface (API). The settings and the capability information for the image forming apparatus can be acquired from Management Information Base (MIB) acquired from an information apparatus through Simple Network Management Protocol (SNMP), which is one of typical protocols. According to the present exemplary embodiment using these techniques, the print control unit 523 issues a capability information acquisition request to the image forming apparatus 103. The image forming apparatus 103 returns the capability information for the image forming apparatus 103 in response to the request from the print control unit 523. The print control unit 523 can acquire information about the function of the image forming apparatus 103 that can be used by the image forming apparatus 103 based on the returned capability information. The print control unit 523 can therefore determine whether to perform the idle printing based on capability information for the image forming apparatus 103. The method, technique, and protocol for acquiring the capability information for each model are not limited to the above-described examples. Original methods provided by vendors of basic software or image forming apparatuses are also applicable.

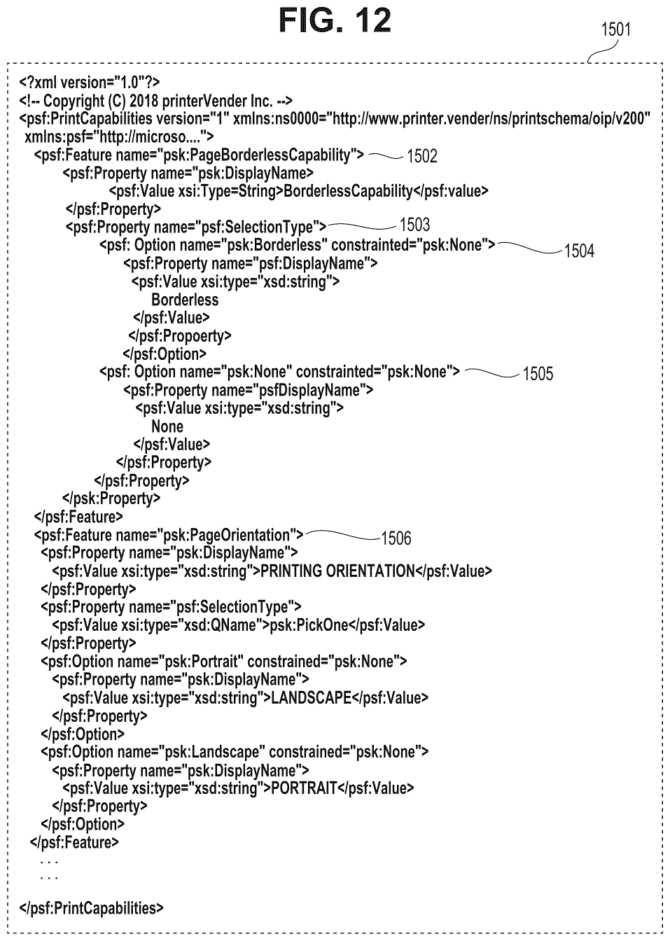

FIG. 12 illustrates an example of information to be returned when the print control unit 523 acquires the capability information for the image forming apparatus 103 by using the method provided by Microsoft® Corporation. Capability information 1501 represents the capability information for the image forming apparatus 103 in the XML format. A character string 1502 indicates the capability information for the borderless printing. A character string 1503 is a list of options for borderless print settings selectable when using the image forming apparatus 103. A character string 1504 is an option indicating that the borderless print setting is possible. A character string 1505 is an option indicating that the bordered print setting is possible. A character string 1506 indicates the capability information for the print direction. The capability information 1501 includes the descriptions of other various capability information for the image forming apparatus 103, but the descriptions will be omitted in the present exemplary embodiment. The use of the information for the character strings 1502 and 1503 allows the on-premise application 517 and other modules and the control unit to determine whether the image forming apparatus 103 supports the borderless printing function.

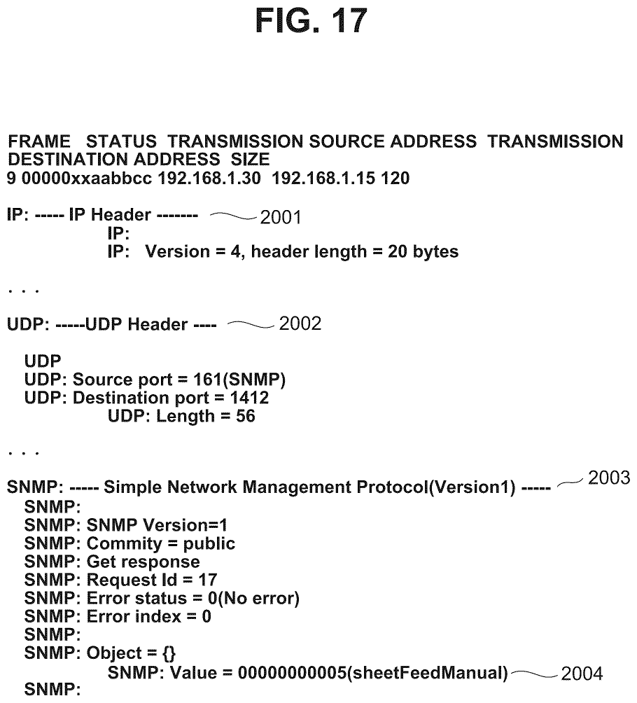

FIG. 17 illustrates an example of MIB information to be acquired from the image forming apparatus 103 by the information processing apparatus 102, i.e., the contents of a response from the image forming apparatus 103 in a case where the information processing apparatus 102 acquires paper feed method capability information serving as capability information for the image forming apparatus 103. The information starting with a character string 2001 indicates information for an IP header. The information starting with a character string 2002 indicates information for a User Datagram Protocol (UDP) header. The information starting with a character string 2003 indicates SNMP information. A character string 2004 indicates that the image forming apparatus 103 responds with the value indicating the use of cut paper feed. For some printer vendors, the print control unit 523 can determine whether the image forming apparatus 103 is an ink-jet image forming apparatus or a toner-based image forming apparatus according to whether the image forming apparatus 103 supports roll paper feed or cut paper feed. Thus, the print control unit 523 can also determine the capability information for the image forming apparatus 103 by using the MIB information.

The present exemplary embodiment acquires the capability information for the image forming apparatus 103 as described above, however, the on-premise application 517 or the print control unit 523 may include a database of models and capabilities of image forming apparatuses. The method for acquiring the capability information is not limited to a particular method but may be any other method.

### <Start of Color Validation Processing>

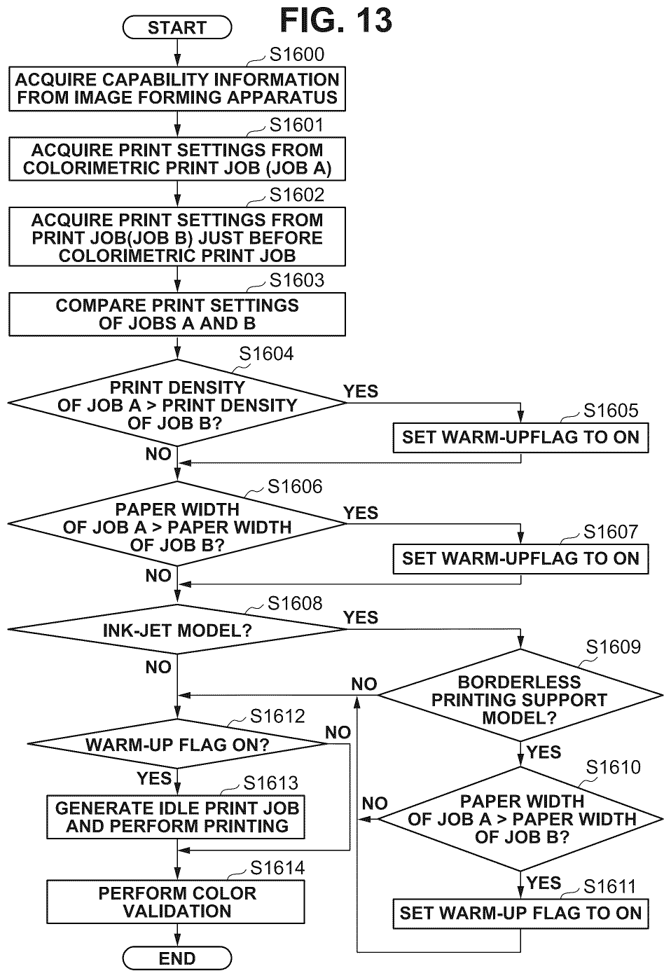

The on-premise application 517 starts the color validation by manual execution by the user or automatic execution by using the scheduling function. In this case, the on-premise application 517 requests the print setting comparison unit 525 to perform processing before starting the color validation. A flow of processing performed by the print setting comparison unit 525 to receive the request and start the color validation will now be described with reference to the flowchart in FIG. 13. This flowchart is executed upon reception of an instruction for executing a color validation print job from the user. Processing of this flowchart is executed in a case where the setting item 321 is checked.

In step S1600, the print setting comparison unit 525 sets the initial value of the warm-up flag to OFF and acquires the capability information from the image forming apparatus 103. The processing proceeds to step S1601. In step S1601, the print setting comparison unit 525 acquires the print setting from a color validation print job. The processing proceeds to step S1602. In step S1602, the print setting comparison unit 525 acquires the print settings of the print job having been executed immediately before from the print job execution historical information. The processing proceeds to step S1603. In step S1603, the print setting comparison unit 525 compares the print settings of a color validation print job (hereinafter referred to as a job A) with the print settings of the print job having been executed immediately before (hereinafter referred to as job B). The processing proceeds to step S1604. The print control unit 523 compares the print density of the job A with the print density of the job B. If the print control unit 523 determines that the print density of the job A is larger than the print density of the job B (YES in step S1604), the processing proceeds to step S1605. If the print control unit 523 determines that the print density of the job A is smaller than or equal to the print density of the job B (NO in step S1604), the processing proceeds to step S1606. In step S1605, the print setting comparison unit 525 sets the warm-up print flag to ON. The processing proceeds to step S1606.

In step S1606, the print setting comparison unit 525 compares the paper width of the job A with the paper width of the job B. If the paper width of the job A is larger than the paper width of the job B (YES in step S1606), the processing proceeds to step S1607. If the paper width of the job A is smaller than or equal to the paper width of the job B (NO in step S1606), the processing proceeds to step S1608. In step S1607, the print setting comparison unit 525 sets the warm-up flag to ON. The processing proceeds to step S1608.

It is known that stains of the platen occur only in the borderless printing with an ink-jet image forming apparatus and that the processing is not performed for a toner-based image forming apparatus. If it is known that the borderless printing is not supported based on the model information, the image forming apparatus 103 does not discharge ink to the outside of paper and hence the platen is not stained. In this case, the determination for stains of the platen is not required. The print setting comparison unit 525 confirms and determines whether the image forming apparatus 103 is an ink-jet model based on the capability information for the image forming apparatus 103 acquired in step $1600.

If the image forming apparatus 103 is not an ink-jet model (NO in step S1608), the processing proceeds to step S1612 since the platen cannot possibly be stained. If the image forming apparatus 103 is an ink-jet model (YES in step S1608), the processing proceeds to step S1609. In step S1609, the print setting comparison unit 525 confirms and determines whether the image forming apparatus 103 supports the borderless printing, based on the capability information. If the print setting comparison unit 525 determines that the image forming apparatus 103 supports the borderless printing (YES in step S1609), the processing proceeds to step S1610. If the print setting comparison unit 525 determines that the image forming apparatus 103 does not support the borderless printing (NO in step $1609), the processing proceeds to step S1612. In step S1610, the print setting comparison unit 525 compares the paper width of the job A with the paper width of the job B. If the paper width of the job A is larger than the paper width of the job B (YES in step S1610), the processing proceeds to step S1611. If the paper width of the job A is smaller than or equal to the paper width of the job B (NO in step S1610), the processing proceeds to step S1612. In step S1611, the print setting comparison unit 525 sets the warm-up flag to ON. The processing proceeds to step S1612.

In step S1612, the print setting comparison unit 525 determines whether the warm-up flag is ON. If the warm-up flag is ON (YES in step S1612), the processing proceeds to step S1613. If the warm-up flag is OFF (NO in step S1612), the processing proceeds to step S1614. In step S1612, the print setting comparison unit 525 determines that the stabilizing processing for the image forming apparatus 103 through the idle printing is required and generates an idle print job. The processing proceeds to step S1614. In the generation of an idle print job, the print setting comparison unit 525 copies the same job as the job A using the print control unit 523, generates an idle print job with the number of copies set to 100, and transmits the idle print job to the image forming apparatus 103 via the communication unit 504 and the printing communication unit 515. In step S1613, upon reception of the idle print job, the image forming apparatus 103 performs the idle printing aiming for the stabilization of the output. The proceeds to step S1614. In step S1614, the print setting comparison unit 525 transmits the job A, which is a color validation print job, to the image forming apparatus 103 and returns control to the on-premise application 517. The on-premise application 517 performs the color validation. The processing exits this flowchart.

The above-described configuration enables the on-premise application 517 to omit unnecessary determination based on the capability information for the image forming apparatus 103 when determining whether to perform printing for the idle print job based on the differences between the print settings. The use of the capability information enables performing correct determination. This improves the accuracy of determining the necessity of the idle printing for the image forming apparatus 103, making it possible to expect an improved operation rate of the image forming apparatus 103.

According to the first exemplary embodiment, the scheduling function determines and performs the idle printing after the color validation execution time comes. However, the user may not desire that the start of the color validation be delayed by the execution of the idle printing. The color validation can desirably be started at the scheduled time if possible. A print job has information about the number of pages, paper type, and paper size. The use of the information included in the print job enables estimating the required printing time, and thus a status monitor, which is a module for displaying the print status of some print applications and print jobs, provides a function of presenting the required time to the user. The print control application 520 similarly estimates the required time and calculates the required time for scheduled printing of print jobs. If the print control application 520 generates a printing schedule for idle print jobs such that each idle print job completes before the scheduled starting time of the color validation comes, the start of the color validation will not be delayed by the execution of the idle printing. According to a third exemplary embodiment as a modification of the first exemplary embodiment, the scheduling function sets the optimum starting time of the idle printing based on the printing schedule acquired from the print control application 520. This enables starting the color validation at the scheduled time even if the idle printing is performed. Basic configurations of the third exemplary embodiment are common to those of the first exemplary embodiment. Descriptions common to those of the first exemplary embodiment will be omitted, and only the points different from the first exemplary embodiment will be described.

<Estimating Printing Time with Print Application>

The print control application 520 has a function of calculating the required printing time based on the print settings included in print jobs stored in the print job storage unit 522 and print jobs received and processed by the print control unit 523. For example, the print control application 520 may calculate the time for printing by referring to only the number of pages of each print job or using a simple formula, such as “Number of pages×30 seconds/page”. The calculation method is not limited thereto.

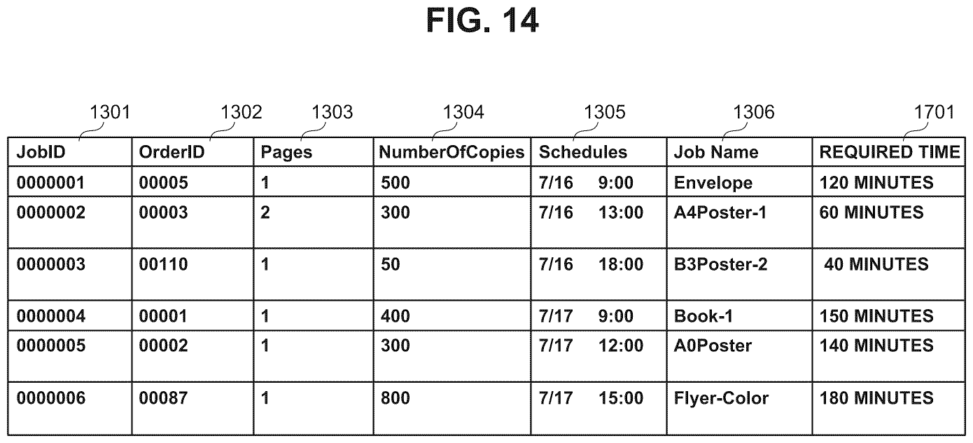

FIG. 14 illustrates a list of scheduled print jobs set in the print control application 520. A column 1701 indicates the required printing time for each print job estimated by the print control application 520. The print control application 520 returns a list of print jobs including the information illustrated in FIG. 14 in response to a request to the print control unit 523.

### <Flow of Processing for Generating Color Validation Schedule>

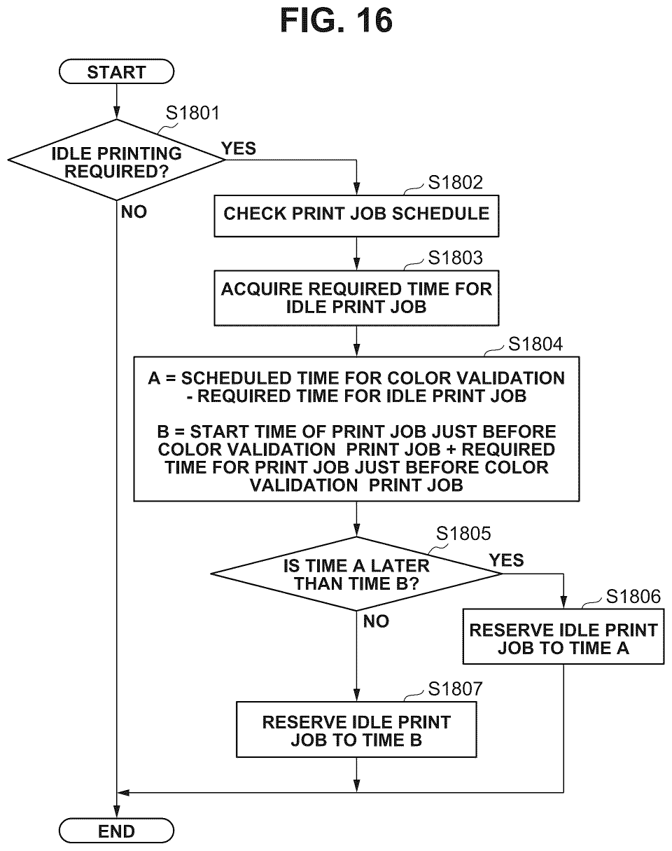

Processing performed by the on-premise application 517 to generate a color validation print job will now be described with reference to the flowchart in FIG. 16. The on-premise application 517 allows the user to register an execution schedule together with the color validation settings via the web browser 507. Upon registration of the schedule, the on-premise application 517 generates a color validation job. Processing of this flowchart may be regularly performed at predetermined intervals or performed by a user's instruction.

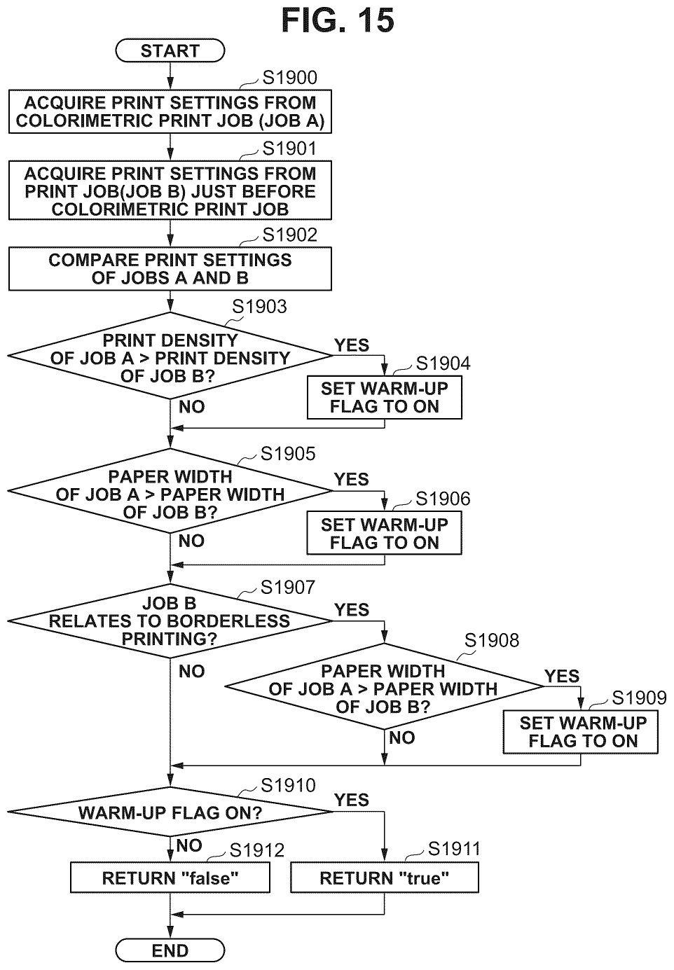

The on-premise application 517 requests the print setting comparison unit 525 to determine the necessity of the idle printing. If the idle printing is required (YES in step S1801), the processing proceeds to step S1802. If the idle printing is not required (NO in step S1801), the processing ends the flowchart. Processing for determining the necessity of the idle printing in step S1801 will be described below with reference to FIG. 15. In step S1802, the on-premise application 517 acquires a list of scheduled printing from the print control application 520 and confirms the scheduled print jobs. The processing proceeds to step S1803. In step S1803, the on-premise application 517 acquires the required printing time for the idle print job. The processing proceeds to step $1804. In step S1804, the on-premise application 517 calculates A (=Scheduled time for color validation—Required printing time for idle print job) and B (=Start time of printing immediately before color validation print job +Required printing time for print job immediately before color validation print job). The processing proceeds to step $1805. The on-premise application 517 compares the above-described times A and B and determines the necessity of the idle printing. If the time A is later than the time B, i.e., if the time earlier than the scheduled time of the color validation by the required printing time for the idle print job is later than the end time of the print job immediately before the color validation print job, the processing proceeds to step S1806. If the time A is earlier than the time B, i.e., if the end time of the printing for the idle print job is later than the start time of the color validation even if the printing for the idle print job is started immediately after completion of the printing for the print job immediately before the color validation print job (NO in step S1805), the processing proceeds to step S1807. In step S1806, the on-premise application 517 sets the idle print job to the print control application 520 such that the idle printing is performed at the time A as reserved printing, the processing exits the flowchart. In step S1807, the on-premise application 517 sets the idle print job to the print control application 520 such that the idle printing is performed at the time B as reserved printing. The processing exits the flowchart.

### <Determining Necessity of Idle Printing>

Processing performed by the on-premise application 517 to request the print setting comparison unit 525 to determine the necessity of the idle printing will now be described with reference to the flowchart in FIG. 15.

In step S1900, the print setting comparison unit 525 sets the initial value of the warm-up flag to OFF and acquires the print settings from the color validation print job. The processing proceeds to step S1901. In step S1901, the print setting comparison unit 525 acquires the print settings of the print job having been executed immediately before from the print job execution history. The processing proceeds to step S1902. In step S1902, the print setting comparison unit 525 compares the print settings of the color validation job (hereinafter referred to as a job A) with the print settings of the print job having been executed immediately before (hereinafter referred to as job B), and the processing proceeds to step S1903. In step S1902, the print setting comparison unit 525 compares the print density of the job A with the print density of the job B. If the print setting comparison unit 525 determines that the print density of the job A is larger than the print density of the job B (YES in step 1903), the processing proceeds to step S1904. If the print density of the job A is smaller than or equal to the print density of the job B (NO in step S1903), the processing proceeds to step S1905. In step S1904, the print setting comparison unit 525 sets the warm-up print flag to ON. The processing then proceeds to step S1905.

In step S1905, the print setting comparison unit 525 compares the paper width of the job A with the paper width of the job B. If the paper width of the job A is larger than the paper width of the job B (YES in step S1905), the processing proceeds to step S1906. If the paper width of the job A is smaller than or equal to the paper width of the job B (NO in step S1905), the processing proceeds to step S1907. In step S1906, the print setting comparison unit 525 sets the warm-up flag to ON. The processing proceeds to step S1907.

In step S1907, the print setting comparison unit 525 checks and determines whether the job B relates to the borderless printing.

If the borderless print setting of the job B is ON (YES in step S1907), the processing proceeds to step S1908. If the borderless the print setting is OFF (NO in step S1907), the processing proceeds to step S1910. In step S1908, the print setting comparison unit 525 compares the paper width of the job A with the paper width of the job B. If the paper width of the job A is larger than the paper width of the job B (YES in step S1908), the processing proceeds to step S1909. If the paper width of the job A is smaller than or equal to the paper width of the job B (NO in step S1908), the processing proceeds to step S1910. In step S1909, the print setting comparison unit 525 sets the warm-up flag to ON. The processing proceeds to step S1910.

In step S1910, the print setting comparison unit 525 checks and determines whether the warm-up flag is ON. If the warm-up flag is ON (YES in step S1910), the processing proceeds to step S1911. If the warm-up flag is OFF (NO in step S1910), the processing proceeds to step S1912. In step S1911, the print setting comparison unit 525 returns a value “true” as a result of the processing for determining the necessity of the idle printing. The processing then exits the flowchart. In step S1912, the print setting comparison unit 525 returns a value “false” as a result of the processing for determining the necessity of the idle printing. The processing then exits the flowchart. If “true” is set for the necessity of the idle printing, the idle printing is determined to be required in step S1801. If “false” is set for the necessity of the idle printing, the idle printing is determined to be not required in step S1801.

The on-premise application 517 transmits the job A as a color validation print job to the image forming apparatus 103 and performs the color validation.

When the on-premise application 517 generates a color validation schedule for performing the idle printing, the above-described configuration enables performing the idle printing in advance so that the scheduled color validation is started at the specified time if possible. The above-described features allow the user to start the color validation at the scheduled time without being delayed by the execution of the idle printing, thus improving user's convenience.

A configuration including at least one of the above-described first to third exemplary embodiments is also applicable.

A recording medium storing a program code of software for implementing the above-described functions may be supplied to a system or an apparatus, and the computer (CPU or micro processing unit (MPU)) of the system or the apparatus may read and execute the program code stored in the recording medium. In this case, the program code itself read from the storage medium implements the functions of the above-described exemplary embodiments, and the storage medium storing the program code configures the above-described apparatus.

Examples of usable storage media for supplying the program code include a flexible disk, a hard disk, an optical disc, a magneto-optical disk, a compact disc read only memory (CD-ROM), a compact disc recordable (CD-R), a magnetic tape, a nonvolatile memory card, a ROM, and a digital versatile disc (DVD).

The above-described functions may also be implemented not only when the computer executes the read program code but also when the operating system (OS) operating on the computer executes part or whole of actual processing based on instructions of the program code.

The program code read from the storage medium is further written to a memory included in a function expansion board inserted into the computer or a function expansion unit connected to the computer.

The CPU included in the function expansion board or the function expansion unit may implement the above-described functions by executing part or whole of actual processing based on instructions of the program code.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2023-138694, which was filed on Aug. 29, 2023 and which is hereby incorporated by reference herein in its entirety.

What is claimed is:

1. A method for an information processing apparatus capable of communicating with an image forming apparatus, the method comprising:
receiving an instruction for causing the image forming apparatus to execute a color validation print job; and
controlling, in a case of causing the image forming apparatus to execute the color validation print job, whether to instruct the image forming apparatus to execute a print job for stabilizing operations of the image forming apparatus, based on print settings of a print job having been executed by the image forming apparatus and print settings of the color validation print job.

2. The method according to claim 1, wherein, in the controlling, whether to instruct the image forming apparatus to execute the print job for stabilizing operations of the image forming apparatus is controlled based on a comparison between the print settings of the print job having been executed immediately before by the image forming apparatus and the print settings of the color validation print job.

3. The method according to claim 1, wherein, in the controlling, in a case where a print density of the print settings of the color validation print job is larger than a print density of the print settings of the print job having been executed immediately before by the image forming apparatus, the image forming apparatus is instructed to execute the print job for stabilizing operations of the image forming apparatus.

4. The method according to claim 1, wherein, in the controlling, in a case where a paper width of the print settings of the color validation print job is larger than a paper width of the print settings of the print job having been executed immediately before by the image forming apparatus, the image forming apparatus is instructed to execute the print job for stabilizing operations of the image forming apparatus.

5. The method according to claim 1, wherein, in the controlling, in a case where the print settings of the print job having been executed immediately before by the image forming apparatus is borderless printing, and a paper width of the print settings of the color validation print job is larger than a paper width of the print settings of the print job having been executed immediately before by the image forming apparatus, the image forming apparatus is instructed to execute the print job for stabilizing operations of the image forming apparatus.

6. The method according to claim 1, further comprising managing information for print jobs having been executed by the image forming apparatus as historical information.

7. The method according to claim 1, wherein, in the controlling, in a case where a print density of the print settings of the color validation print job is not larger than a print density of the print settings of the print job having been executed immediately before by the image forming apparatus, the image forming apparatus is instructed not to execute the print job for stabilizing operations of the image forming apparatus.

8. The method according to claim 1, further comprising receiving from a user a setting about whether control in the controlling is to be performed.

9. The method according to claim 1, wherein, in the controlling, whether to instruct the image forming apparatus to execute the print job for stabilizing operations of the image forming apparatus is controlled, based on the print settings of the print job having been executed immediately before by the image forming apparatus, the print settings of the color validation print job, and capability information for the image forming apparatus acquired from the image forming apparatus.

10. The method according to claim 1, wherein the print job for stabilizing operations of the image forming apparatus is a job for printing a predetermined number of sheets based on the print settings of the color validation print job.

11. The method according to claim 1, further comprising:
generating a schedule indicating scheduled jobs to be executed by the image forming apparatus; and
executing, in a case where the print job for stabilizing operations of the image forming apparatus is determined to be executed in the controlling, the print job in advance of the schedule.

12. The method according to claim 1, further comprising performing color validation by comparing a colorimetric value of a print product output by the image forming apparatus based on the color validation print job with a reference value.

13. A non-transitory computer-readable storage medium that stores computer-executable instructions that, when executed by one or more processors of an information processing apparatus capable of communicating with an image forming apparatus, cause the information processing apparatus to perform a control method, the control method comprising:
receiving an instruction for causing the image forming apparatus to execute a color validation print job; and
controlling, in a case of causing the image forming apparatus to execute the color validation print job, whether to instruct the image forming apparatus to execute a print job for stabilizing operations of the image forming apparatus, based on print settings of a print job having been executed by the image forming apparatus and print settings of the color validation print job.

14. An information processing apparatus capable of communicating with an image forming apparatus, the information processing apparatus comprising:
at least one memory storing instructions; and
at least one processor that is in communication with the at least one memory and that, when executing the instructions, cooperates with the at least one memory to:
receive an instruction for causing the image forming apparatus to execute a color validation print job; and
control, in a case of instructing the image forming apparatus to execute the color validation print job, whether to instruct the image forming apparatus to execute a print job for stabilizing operations of the image forming apparatus, based on print settings of a print job having been executed by the image forming apparatus and print settings of the color validation print job.
